(19) United States
(12) Patent Application Publication
(10) Pub. No.: US 2012/0066925 A1
(43) Pub. Date: Mar. 22, 2012

(54) Device and Method For Quieting a Clothes Dryer

(76) Inventors: Todd Ahlf, Scottsdale, AZ (US); Brad Ahlf, Scottsdale, AZ (US); Tom Ahlf, Bloomingdale, IL (US)

(21) Appl. No.: 12/887,399

(22) Filed: Sep. 21, 2010

(51) Int. Cl. D06F 58/04; B32B 37/12; B32B 37/14; F16F 15/00

(52) U.S. Cl. 34/108; 181/209; 156/60; 156/297

(57) ABSTRACT

For application in a clothes dryer, a quieting device acts to considerably reduce the noise from objects hitting the drum as clothes are being spun dry. The quieting device comprises padding applied to inside surfaces of the drum, the padding including an adhesive on a side thereof, the adhesive for adhering the padding to the inside surfaces. Preferably, the adhesive is a pressure-sensitive, heat-resistant adhesive. In an embodiment of the invention, the padding includes a plurality of strips of the padding, each of which is placed on the inside surfaces of the drum between the dryer fins. In alternative embodiments, the strips of padding can be placed atop the dryer fins. In an embodiment of the invention, the material includes a plurality of holes to allow for heat from the drum surface to escape through the holes, so the device does not inhibit drying of the clothes.

### FIELD OF THE INVENTION

The present invention relates to noise reduction techniques, and, more particularly, to a device for quieting a clothes dryer and a method for applying the device to the drum of a clothes dryer.

### BACKGROUND

Because clothes dryers can produce excessive noise, some manufacturers have added sound-deafening material to various parts of the appliance, including the doors, top, sides, motor, and blower. Although this material serves to quiet overall operation, it does not silence the noise from metal objects, such as zippers, hitting the drum as the clothes are spun dry.

### SUMMARY OF THE INVENTION

For application in a clothes dryer, a quieting device acts to considerably reduce the noise from objects hitting the drum as clothes are being spun dry. The quieting device comprises padding applied to inside surfaces of the drum, the padding including an adhesive on a side thereof, the adhesive for adhering the padding to the inside surfaces. Preferably, the adhesive is a pressure-sensitive, heat-resistant adhesive. In an embodiment of the invention, the padding includes a plurality of strips of the padding, each of which is placed on the inside surfaces of the drum between the dryer fins. In alternative embodiments, the strips of padding can be placed atop the dryer fins. In an embodiment of the invention, the material includes a plurality of holes to allow for heat from the drum surface to escape through the holes, so the device does not inhibit drying of the clothes.

According to an embodiment of the invention, a method for quieting a clothes dryer comprises applying the padding to inside surfaces of a drum.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows an exemplary device for quieting a clothes dryer, according to a preferred embodiment of the present invention;

FIG. 2 shows a close-up side view of an exemplary padding strip useable for the device;

FIG. 3(a) shows strips of the exemplary device applied to inside surfaces of a clothes dryer drum between dryer fins;

FIG. 3(b) shows strips of the exemplary device applied to dryer fins of a clothes dryer;

FIG. 4 shows an exemplary method of cutting sheets of the material to make the exemplary device;

FIG. 5(a) shows an individual strip of the material without holes; and

FIG. 5(b) shows an individual strip of the material with holes.

### DETAILED DESCRIPTION

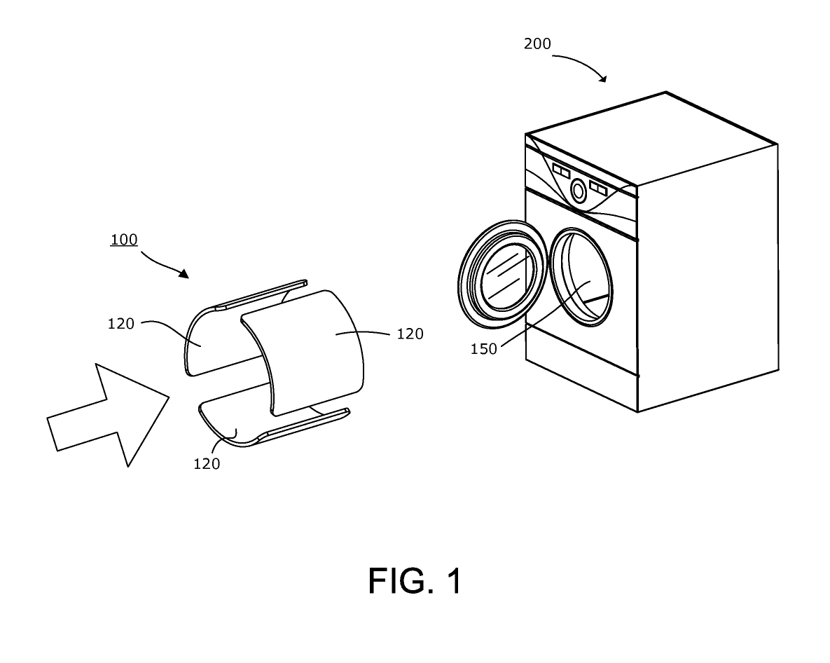

FIG. 1 illustrates an exemplary quieting device 100 for quieting a clothes dryer 200, according to a preferred embodiment of the present invention. As depicted, the quieting device 100 includes a plurality of padding strips 120 which are inserted into the clothes dryer drum 150. As will be described in greater detail, each of the padding strips 120, preferably, is made from a relatively soft material and includes an adhesive on a surface thereof. The padding strips 120 are applied to inner surfaces of the drum 150 in such a way so as to shield objects from directly hitting the drum 150.

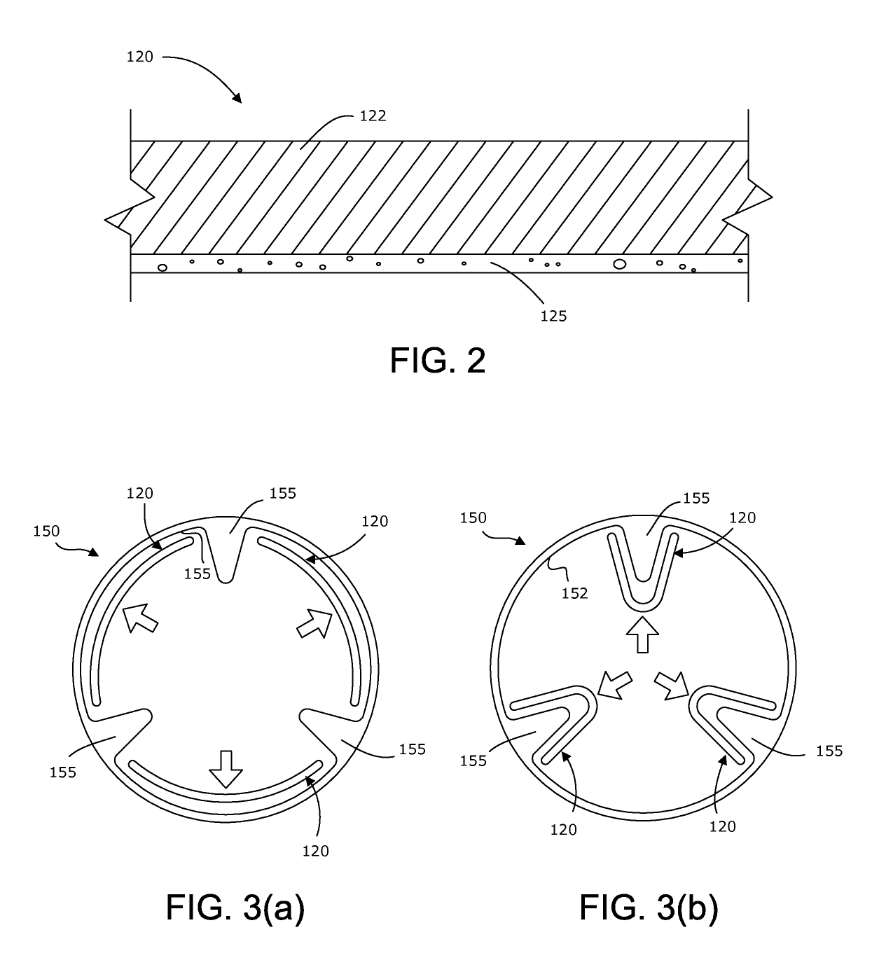

FIG. 2 shows a close-up side view of an exemplary padding strip 120 useable for the quieting device 100. As depicted, the padding strip 120 includes a padding material 122 with a layer of adhesive 125 on a surface thereof. Preferably, the padding material will be either a heat resistant soft cloth material (such as cotton or linen) or a viscoelastic material such as polychloroprene (sold under various brand names, including NEOPRENE) having good chemical stability and which maintains itself at typical clothes dryer temperatures (approximately 140 to 160 degrees Fahrenheit). Preferably, the adhesive will be a pressure-sensitive, heat resistant adhesive. An example of a suitable adhesive is the MORSTIK 117 synthetic rubber-based pressure-sensitive adhesive, by Dow Chemical Company, of Midland, Mich.

It is to be understood that a vast number of different materials and adhesives exist which could be used in conjunction with the present invention. In general, the materials and adhesives chosen should be able to sufficiently operate under temperatures found in most clothes dryers. Additionally, it is to appreciated that although a pressure-sensitive adhesive is described herein as the preferred adhesive, the quieting device 100 could, instead, be permanently bonded to inside surfaces of the drum 150. In such a case, the quieting device 100 could be applied during manufacture of the clothes dryer 200 at the factory, for example.

FIG. 3(a) shows strips of the exemplary device applied to inside surfaces 155 of a clothes dryer drum 150 between dryer fins 152. In this case, each of the padding strips 120, is, preferably, a rectangular strip with a width approximately matching the distance between the dryer fins 155. When sold commercially, the quieting device 100 can include either a set of pre-cut rectangular padding strips 120 or a continuous padding strip 120 to be cut into individual strips by the consumer. In an alternative embodiment, as shown in FIG. 3(b) the padding strips 120 can be applied to the dryer fins 155. In still other embodiments, the quieting device 100 can be applied entirely across the inside surface 155 of the dryer 200.

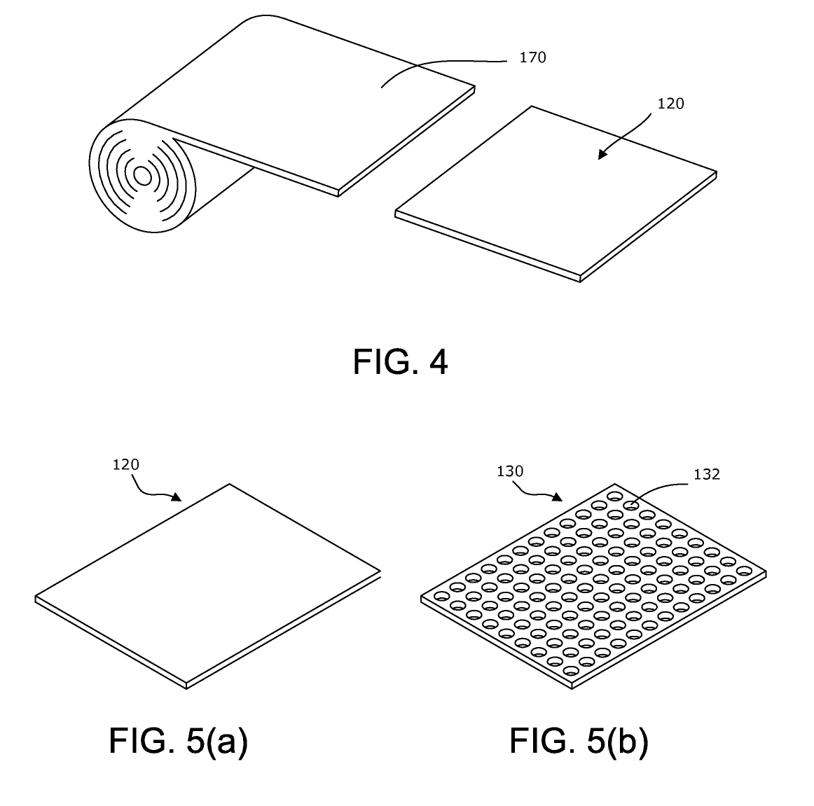

Manufacture of the quieting device 100 is straightforward. Referring to FIG. 4, individual padding strips 120 can be cut from a roll of material 170 (using a cloth cutting machine, or by hand). FIG. 5(a) shows an individual padding strip 120 cut from the roll 170. Preferably, the adhesive 125 is placed on the padding material 125 before the padding strips 120 are cut from the roll 170.

Referring to FIG. 5(b), a padding strip 130 can, alternatively, include a plurality of holes, such as hole 132, to allow for heat from the drum surface to escape through the holes, so the device does not inhibit drying of the clothes. The holes can be made in the padding strips 130 in a variety of ways, such as by using a punching machine; alternatively, a mesh-type fabric can be used.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. For application in a clothes dryer, a quieting device, the quieting device comprising:
padding applied to inside surfaces of the drum of the clothes dryer, the padding including an adhesive on a side thereof, the adhesive for adhering the padding to the inside surfaces.

2. The quieting device of claim 1, wherein the padding includes a plurality of strips of padding.

3. The quieting device of claim 2, wherein each of the strips of padding is placed between dryer fins of the drum.

4. The quieting device of claim 1, wherein the padding is placed over dryer fins of the drum.

5. The quieting device of claim 1, wherein the adhesive is a pressure-sensitive adhesive.

6. The quieting device of claim 1, wherein the adhesive is heat-resistant.

7. The quieting device of claim 1, wherein the padding includes a plurality of holes.

8. The quieting device of claim 1, wherein the padding is made from a viscoelastic material.

9. The quieting device of claim 1, wherein the viscoelastic material is polychloroprene.

10. The quieting device of claim 1, where the padding is made from a cloth material.

11. A method for quieting a clothes dryer, comprising:
applying padding to inside surfaces of a drum of a clothes dryer, the padding including an adhesive on a side thereof, the adhesive for adhering the padding to the inside surfaces;
whereby, when the clothes dryer is operated to dry clothes, metal parts of the clothes striking the padding produce less audible noise than would be the case had the padding not been applied.

12. The method of claim 11, wherein the padding includes a plurality of padding strips.

13. The method of claim 12, wherein each of the padding strips is placed between dryer fins of the drum.

14. The method of claim 11, wherein the padding is placed over dryer fins of the drum.

15. The method of claim 11, wherein the adhesive is a pressure-sensitive adhesive.

16. The method of claim 11, wherein the adhesive is heat-resistant.

17. The method of claim 11, wherein the padding includes a plurality of holes.

18. The method of claim 11, wherein the padding is made from a viscoelastic material.

19. The method of claim 18, wherein the viscoelastic material is polychloroprene.

20. The method of claim 11, where the padding is made from a cloth material.
